(19) United States
(12) Patent Application Publication
(10) Pub. No.: US 2019/0155923 A1
(43) Pub. Date: May 23, 2019

(54) INTERNET MAP VIRTUAL MARKER DYNAMIC MANAGEMENT THEORY AND METHOD

(71) Applicants: Qiang Wang, San Jose, CA (US); Yong Wang, San Jose, CA (US); Jin Wang, San Jose, CA (US); Xinwei Wang, San Jose, CA (US); Zhaoyang Wang, San Jose, CA (US)

(72) Inventors: Qiang Wang, San Jose, CA (US); Yong Wang, San Jose, CA (US); Jin Wang, San Jose, CA (US); Xinwei Wang, San Jose, CA (US); Zhaoyang Wang, San Jose, CA (US)

(73) Assignees: QAING WANG, San Jose, CA (US); XINWEI WANG, San Jose, CA (US); YONG WANG, San Jose, CA (US); JIN WANG, San Jose, CA (US)

(21) Appl. No.: 15/821,813

(22) Filed: Nov. 23, 2017

(51) Int. Cl. G06F 17/30; H04W 4/021; H04L 29/08

(52) U.S. Cl. CPC G06F 17/30241; G06F 17/3087; H04L 67/02; H04W 4/021

(57) ABSTRACT

The present invention discloses a completely innovative theory and method of macroscopic dynamic management of internet/web map markers on mobile devices such as smartphones and PCs, which is characterized by using accurate latitude and longitude coordinates to represent virtual internet/web entities that do not exist here at all but somewhere else or completely do not exist in the real world, and the markers will realistically represent these virtual entities on the internet/web map and give users the same feeling as real entities and markers. By pioneering and implementing the concepts of internet/web virtual markers, virtual business, virtual business entities and virtual entity tables, the present invention can greatly stimulate the economic activities of the network to bring about tremendous commercial benefits to businesses and customers with low cost, high efficiency and quick response.

### FIELD OF INVENTION

The present invention relates to the field of internet map markers. More particularly the invention relates to the theory and method for dynamic management of virtual markers of internet map.

### BACKGROUND

Our invention mainly solves the problem that, unlike the real internet map marker on which everybody uses, the internet map virtual marker does not seem to make any sense to the common people. Clicking on the marker of a nonexistent business entity may be a waste of time.

However, anything has two side effects and internet virtual markers that seem to make no sense to the common people are very important for a certain type of people and certain organizations in some cases, this in some cases spawns the need for virtual markers.

Some of these organizations are the state, the army, the police, the national defense, etc. They can use virtual markers to represent completely NO real entities in real world to confuse their opponents, cheat their enemy, create necessary chaos, divert dangerous strikes, misleading, etc. to reach their strategic and tactical deception goals. In addition, some business merchants can also use virtual entities and virtual markers as the virtual agents in prime and valuable locations in a city of a country where they consider themselves commercially viable with a very low cost and they can remotely control allc business transactions online by themselves, All these are attributed to the concept of virtual markers.

At present, there are no ways for Internet maps such as GoogleMap and Baidu Map etc to address the above issues.

Our invention, for the first time in the world, presents the theoretical concepts and methodology of the dynamic management of virtual markers of internet map in an initial and complete way. Our invention provides solutions for the creation of virtual markers for internet maps to address the above issues.

We invented the theory and method of dynamic management for the internet map virtual marker, which is characterized by using accurate latitude and longitude coordinates to represent some of the virtual internet entities that do not exist here at all or completely do not exist in the real world, and the markers will realistically represent these virtual entities on the internet map and give users the same feeling as real entities and real markers. By pioneering and implementing the concepts of internet virtual markers, virtual business, virtual business entities and virtual entity tables, the present invention can greatly stimulate the economic activities of the internet to bring about tremendous commercial benefits to businesses and customers. The invention opens up entirely new fields that are not involved in the current internet maps such as Google Map, QQ Map, MAPQUEST Map, Sohu Map, Baidu Map, GaoDe Map, European HERE Map and Apple Map. The present invention fills in the gaps of dynamic management of internet map virtual marker theory and technology. The Virtual Marker Dynamic Management is a management system that includes an internet map, an internet map virtual marker, a fully virtual markerand a mirror virtual marker, a fully virtual entity and a mirror virtual entity, a virtual merchant interface, a virtual merchant interface tab or tab, a virtual merchant Entity and Business Entity Table, virtual business information, a group of control buttons, B2C interactive interfaces.

The invention expands the traditional static two-dimensional simple internet map markers into dynamic three-dimensional or multi-dimensional composite internet map markers.

### BRIEF SUMMARY OF INVENTION

The present invention discloses a completely innovative theory and method of macroscopic dynamic management of internet map markers on mobile devices such as smartphones and PCs, which is characterized by using accurate latitude and longitude coordinates to represent the virtual internet entities that do not exist here at all but somewhere else or completely do not exist in the real world, and the markers will realistically represent these virtual entities on the internet map and give users the same feeling as real entities and markers. By pioneering and implementing the concepts of internet virtual markers, virtual business, virtual business entities and virtual entity tables, the present invention can greatly stimulate the economic activities of the internet to bring about tremendous commercial benefits to businesses and customers with low cost, high efficiency and quick response.

### BRIEF DESCRIPTION OF DRAWINGS

Some of the embodiments of the present invention are illustrated as an example and are not limited by the figures of accompanying drawings, in which like references may indicate similar elements and in which:

FIG. 1 Virtual marker Concept.

In all markers within the specified radius (1 mile) of the specified location (user's current location);

101 and 104 are the mirroring virtual markers, which represent the real entity merchants in the background real world. However, the coordinates and address here are virtual and the business merchant is real. The marker 101 is virtual mirroring marker of an ordinary single merchant entity and it is only one mirroring virtual entity to represent its real business merchant entity behind, and 104 is the mirroring virtual group marker for several entity merchants, and 110 is one of the plurality of entity merchants mirroring a single entity in the virtual group marker 104, that is, one of the 10 mirroring virtual entities with the same coordinate but different addresses. The other nine are mirroring virtual markers of the other nine mirroring virtual entities, and the number 10 on the marker 104 represents that one mirroring virtual group marker 104 contains 10 mirroring virtual entities with the same address and different coordinates.

Similarly, 102 and 105 are full virtual markers to represent the merchant entities that do not exist in the real world. Not only the coordinate and address are virtual but also the merchant entity is virtual, ie., no this merchant entity exists at all. 102 is full virtual marker and only one full virtual entity; 105 is a full virtual group marker of multiple entity merchants with the same coordinates and same address, and the 109 is one of five full virtual entities with the same address and the same address. The other four are full virtual markers of the other four full virtual entities, and the number 5 on the marker 105 represents an full virtual marker that contains five identical addresses of the same coordinates.

107 is a mirroring virtual merchant entity of the mirroring virtual marker, that is, the merchant actually does exist and has his address elsewhere, but the merchant did not have real address at the current marker's calibration position, and the address of the marker calibration is 12345 King Rd, San Jose, Calif. 95122. The real address of the business is 427 South 5^{th Street}, San Jose, Calif. 95121, USA, this is the real address of this business merchant, it does exist.

108 is a full virtual business entity of full virtual marker, that is, there is no this business entity at all, the address 12111 South King Road, San Jose, Calif. 95122 does not exist at all, and there is no other address for this business elsewhere.

FIG. 2 Virtual Same Coordinate Same Address Group Marker Concept.

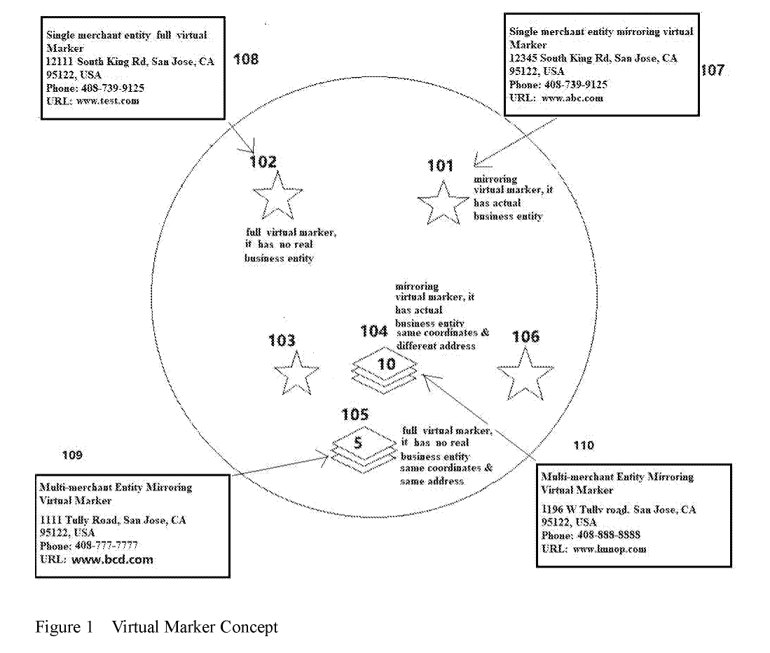

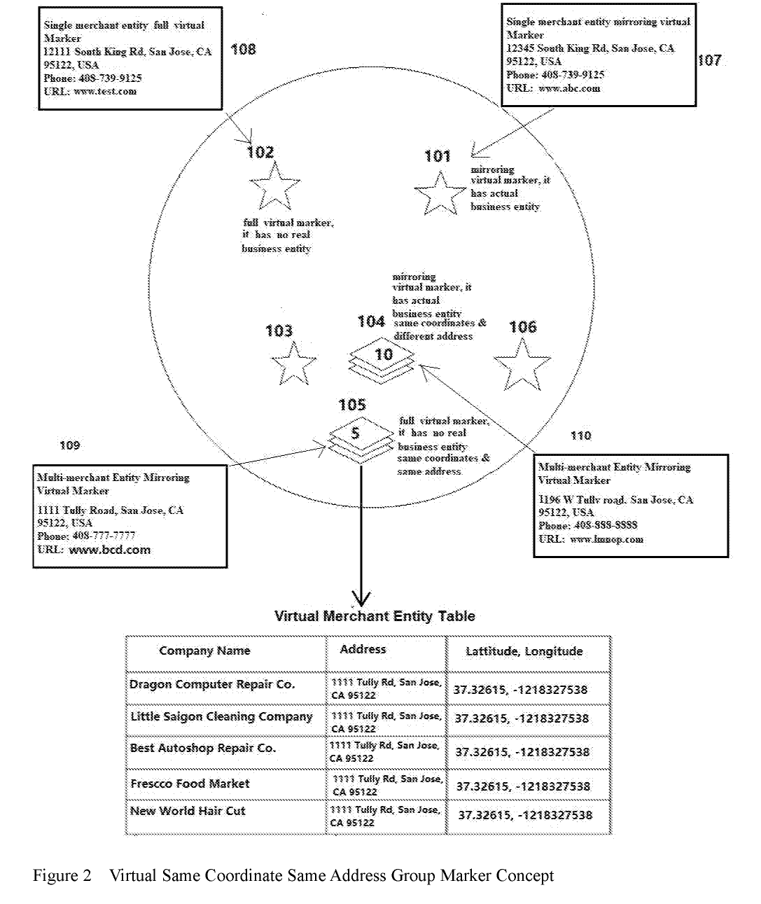

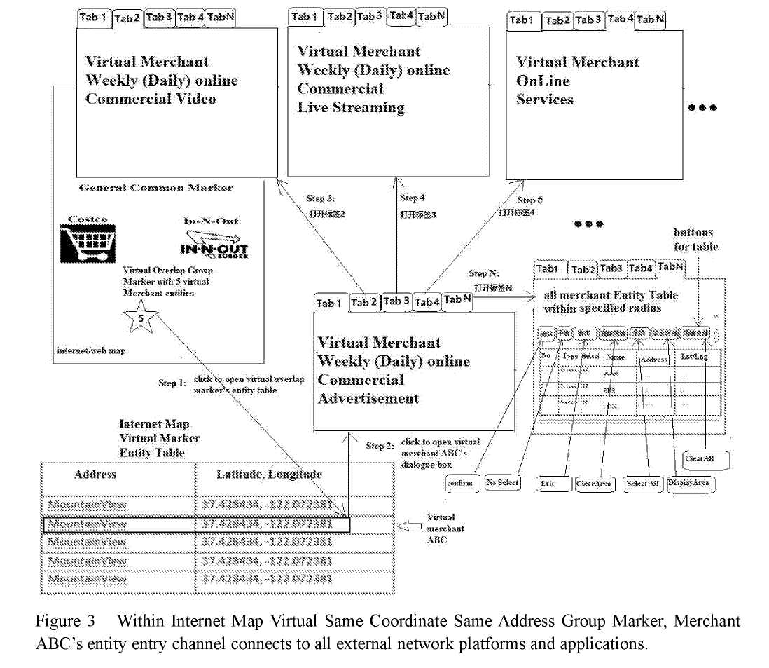

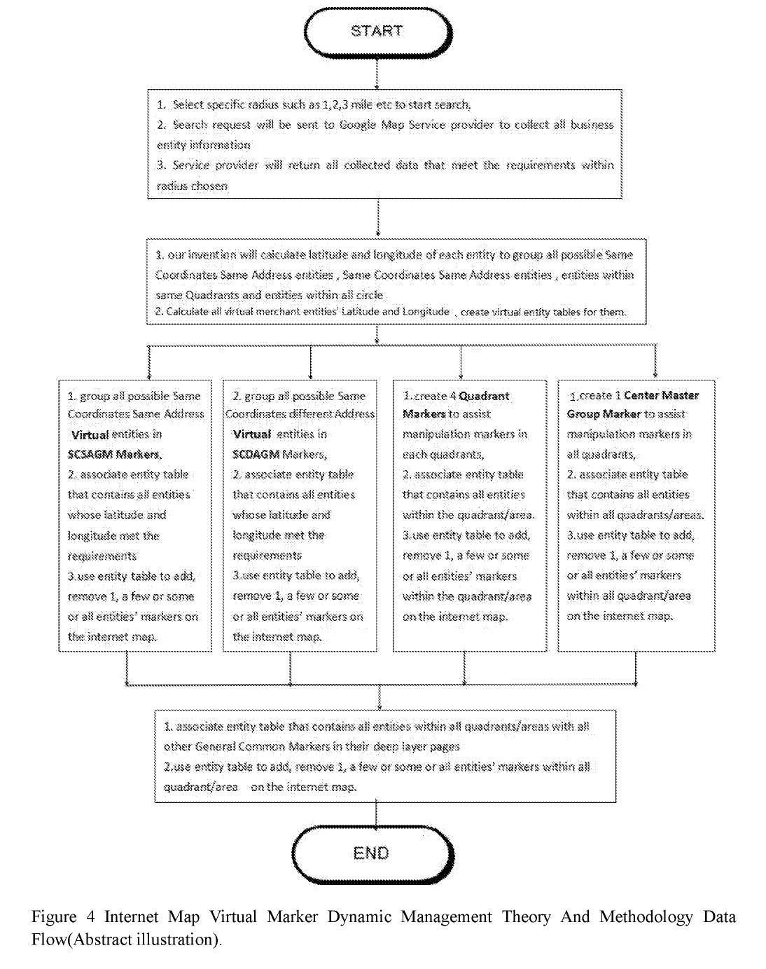

See FIG. 1 above for an explanation of the concept of virtual markers.

FIG. 3 Within Internet Map Virtual Same Coordinate Same Address Group Marker, Merchant ABC's entity entry channel connects to all external internet platforms and applications.

It indicates that this full virtual overlapping marker has 5 different business entities or merchants, all of which have the same latitude, same longitude and the same address, and the full virtual merchant ABC is one of them.When you click on the full virtual overlap marker to get the full Virtual Entity Table, then you can clearly see each of these full virtual business entities and their connections with external platforms.

FIG. 4 Internet Map Virtual Marker Dynamic Management Theory And Methodology Data Flow (Abstract illustration).

### DETAILED IMPLEMENTATION DESCRIPTION

The technical solutions in the embodiments of the present invention will be described clearly and completely below. Obviously, the described embodiments are only a part but not all embodiments of the present invention. All other embodiments obtained by persons of ordinary skill in the art based on the embodiments of the present invention without creative efforts shall fall within the protection scope of the present invention.

Referring to FIG. 1-4, an embodiment of the present invention includes:

Step 1: The place is the point where the current user is located or when the user clicks any point interested on the internet map, user takes all business type set as default and value within the radius of 1 KM or 1 mile as default also in the user's mobile phone or laptop (the user may also select drop-down menu in the radius of choice and business type) then press button to send the request to internet map providers such as GoogleMap, Baidu Map;

Step 2: The mobile terminal user submits the request with the defaults by one click. The server/service provider (including the server and database providing the virtual merchant information) returns all the data requested by the user, and the information returned by the service provider including latitude and longitude, names and types of virtual business entities, virtual business entities' phones, virtual websites, virtual online video and other information;

Step 3: Mobile devices(smartphone, PC etc) will execute our invented android app program based on the returned information to calculate all coordinates for each business entities, place all markers within circle of the specified radius, at the same time, it will automatically complete the following tasks:
Task a: automatically generate each entity table to contain all business entities (including virtual merchants) of the specified business type within the specified range for each marker;
Task b: the general common markers and overlap group markers are generated (Including the same coordiante same address group marker for both real and virtual merchant entity, creating entity tables for them also), the overlap entity table includes all the merchant entities in the overlap markers, and the number of all the entities in each overlap marker is displayed on the corresponding overlap marker,
Task c: automatically generate the virtual group markers of the same virtual coordinates same virtual address and the virtual group markers of the different virtual address but same virtual coordinates and generate the corresponding the entity tables for these two virtual group markers, these two types of markers are not the same,
Task d: connect All virtual group markers with the same address same coordinates with their corresponding business Entity Table, Connect All virtual group markers with the different address same coordinates with their corresponding virtual business Entity Table, Connect All virtual general common markers with their corresponding virtual business entity Table,

Step 4: if the algorithm is running abnormally, the system will deal with the results of the corresponding treatment such as error and exception handling,

Step 5: if the algorithm is running normally, the system displays all the markers on the internet map of the mobile terminal after the operation completed.

### A Specific Embodiment

Taking FIG. 2 as an example, when the user clicks on the virtual overlap marker 105 (see FIG. 2 Virtual Same Coordinate Same Address Group Marker Concept), data is read out from the memory of the mobile terminal by the app at this moment, all the 5 virtual Same Coordinate Same Addres shopping malls and their related records and information are fetched from the memory and the corresponding virtual Same Coordinate Same Address virtual merchant entity table has been generated and created. When the user clicks the virtual overlapping group marker 105, The corresponding user interface will fully display the complete virtual business entity table.

In addition, it can be seen from FIG. 3 that in our invented method, when the user clicks on each of the entities in the business entity table of the virtual overlap group marker 105 (virtual same coordinate same address), a user interface with a number of interface tabs is displayed, the user can use each interface tab to connect to all possible external platforms of the virtual merchant represented by this marker, where the user can conveniently browse the other platforms of the virtual merchant without exiting the current task or current session, users can also perform bidirectional communication and conduct necessary internet transactions, it greatly enhanced the web map functions.

The above descriptions are merely examples of the present invention, and are not intended to limit the scope of the present invention. All equivalent structures or equivalent flow transformations made by using the contents of the present invention are directly or indirectly used in other related technical fields The same shall be included in the protection scope of the present invention. Furthermore, the appended claims of the present invention are intended to cover all changes and modifications that fall within the metes and bounds of the appended claims, or equivalents of such metes and bounds.

What is claimed is:

1. Initiate and implement the concept of
A dynamic management theory and method of internet map virtual markers, which is characterized by using precise latitude and longitude coordinate values to construct some internet/web virtual entities that do not exist here or do not exist in the real world at all, and markers display these virtual entities on the web map. The present invention pioneers and implements the concepts of internet/web virtual markers, virtual merchants, virtual merchant entities and virtual entity tables.

2. A dynamic management theory and method of internet map virtual marker is characterized in that:
Virtual Marker Dynamic Management is a management system that includes a internet/web map, a web map virtual marker, a full virtual marker and a mirror virtual marker, a full virtual entity and a mirror virtual entity, a virtual merchant interface, a virtual merchant interface tab or tab, a virtual merchant entity and Business entity table, virtual business information, a group of control buttons, B2C interactive interfaces.

3. A dynamic management theory and method of internet map virtual marker is characterized in that:
the traditional static two-dimensional simple internet map marker is expanded into a dynamic three-dimensional or multi-dimensional composite internet map marker.

4. A dynamic management theory and method of internet map virtual marker of claim 1, characterized in that:
internet map virtual marker management is also a subsystem of the macro management system of an internet map marker invented by us, thus it inherits all its basic markers, business interface, business entities and business entity tables, business information, a group of control buttons, B2C interactive interface and interface tab elements. Also it inherits all features and management methods of the macro management system of internet map marker. But these its business merchant entity information is virtual, that does not exist in real life, the virtual business and virtual information exists only in the databases in the service providers. The special features of the virtual markers and virtual entities of the internet map is its virtual aura, which is a typical virtual object that is built entirely for some purpose.

5. A dynamic management theory and method of internet map virtual marker of claim 1, characterized in that:
a. All internet map virtual markers can be accurately positioned, precisely managed and operated correctly through the two-dimensional virtual merchant entity table;
b. A virtual business virtual marker can find its unique location in the entity table;
c. Two-dimensional virtual business entity table can be used to represent a virtual business entity of the same coordinates (same latitude and same longitude) in three-dimensional space;
d. Each virtual merchant entity's name, phone number, address and the like in the virtual merchant entity table are the interface for bi-directional conversation between the user and the virtual merchant or the channel to connect to the virtual merchant external network application platform.

6. A dynamic management theory and method of internet map virtual marker of claim 1, characterized in that:
The theory and method of the present invention are universal and suitable for all Internet map applications in computer and mobile applications in the world at present such as Google Map, MapQuest map, AppleMap, Baidu map, QQ map, GaoDe map, Sohu Map, HERE map of Europe.

8. A dynamic management theory and method of internet map virtual marker of claim 1, characterized in that:
An internet virtual marker definition can be extended to any shape of oval, square, rectangle, polygon in static as well as dynamic, as well as planes or surfaces on which these shapes are located and their deformation containers, including actual real and Virtual Reality or holographic containers or platforms.
